(19) United States
(12) Patent Application Publication
(10) Pub. No.: US 2020/0358156 A9
(43) Pub. Date: Nov. 12, 2020

(54) SECONDARY CELL, ACCUMULATOR COMPRISING ONE OR MORE SECONDARY CELLS, AND METHOD FOR CHARGING AND DISCHARGING

(71) Applicants: Deutsches Zentrum fuer Luft- und Raumfahrt e.V., Koeln (DE); CIDETEC, Donostia/San Sebastián (ES)

(72) Inventors: Dennis Wittmaier, Vaihingen (DE); Norbert Wagner, Gersthofen (DE); Alexander Kube, Filderstadt (DE); Alberto Blázquez, Pasajes (ES); Aroa Ramos, Irun (ES)

(21) Appl. No.: 16/427,519

(22) Filed: May 31, 2019

Related U.S. Application Data
(63) Continuation of application No. PCT/EP2017/080791, filed on Nov. 29, 2017.

(30) Foreign Application Priority Data
Dec. 2, 2016 (EP) 16201937.6

(51) Int. Cl. H01M 12/08; H01M 4/34; H01M 4/38; H01M 4/86; H01M 4/88; H01M 4/90

(52) U.S. Cl. CPC H01M 12/08; H01M 4/34; H01M 4/38; H01M 4/8605; H01M 2004/027; H01M 4/8668; H01M 4/8807; H01M 4/9016; H01M 2004/8689; H01M 4/8652

(57) ABSTRACT

The present invention relates to a secondary cell in the form of a hybrid system of a zinc-air battery and a silver oxide-zinc battery, comprising an anode, a cathode, and an electrolyte. The anode contains zinc (Zn) and/or zinc oxide (ZnO2), and the cathode is configured as a gas diffusion electrode which contains a mixture of silver (Ag) and/or silver oxide (Ag2O/AgO) with a catalyst for the electrochemical oxygen evolution, wherein the catalyst is selected from cobalt oxide Co3O4), manganese oxide (Mn3O4 or MnO2), cobalt-nickel oxide (CoNiO2), lanthanum-calcium-cobalt oxide (LaxCa1-xCoO3), ruthenium oxide (RuO2), iridium oxide (IrO2), platinum (Pt), palladium (Pd), and mixtures thereof.

The invention further relates to an accumulator which comprises one or a plurality of secondary cells, as well as a method for charging and a method for discharging a secondary cell or an accumulator.

The present invention relates to a secondary cell in the form of a hybrid system of a zinc-air battery and a silver oxide-zinc battery, comprising an anode, a cathode, and an electrolyte.

The invention further relates to an accumulator which comprises one or a plurality of secondary cells.

Furthermore, the invention relates to a method for charging and a method for discharging a secondary cell or an accumulator.

Metal-air batteries are distinguished from most other battery types by a significantly higher gravimetric and volumetric energy density, which is due in particular to the fact that only one of the two reaction partners contributes to the starting weight of the cell, while the oxygen is supplied from the ambient air. For this reason, metal-air batteries are of great practical importance in particular for mobile applications, for example as energy stores in electric vehicles. Most widespread in this field are lithium-air batteries and lithium-air accumulators, respectively, which have the further advantage that the electrochemical oxidation of lithium is reversible in principle, and that this system may also be used in practice as a secondary cell with a multitude of charging and discharging cycles.

On the other hand, the use of lithium also involves disadvantages, which are constituted in particular in the limited availability, the high costs, and the high reactivity of lithium (which makes the use of an organic electrolyte necessary). Zinc, which is relatively inexpensive and is available in sufficient quantities, lends itself as an alternative metal for the anode side of a metal-air battery. In addition, zinc leads to a lesser environmental impact upon disposal in comparison to lithium.

Zinc-air batteries are known from the prior art, though they have the decisive disadvantage compared to lithium-air batteries that, in practice, they cannot be operated, or at least not economically, as secondary cells, because the recharging involves significant problems. Reasons for this are, among other things, the cathode materials used in the zinc-air batteries, which have only a low catalytic activity for the electrochemical oxygen evolution. In addition, the cathodes contain carbon in order to ensure electrical conductivity, though which, under the conditions of oxygen evolution, already corrodes at potentials just above the open cell voltage. This leads to an impairment in function and ultimately to a structural degradation of the cathode.

The object underlying the invention is therefore to provide a rechargeable secondary cell on the basis of a zinc-air battery.

This object is achieved in accordance with the invention in the secondary cell of the kind stated at the outset in that the anode contains zinc (Zn) and/or zinc oxide (ZnO₂), and in that the cathode is configured as a gas diffusion electrode which contains a mixture of silver (Ag) and/or silver oxide (Ag₂O/AgO) with a catalyst for the electrochemical oxygen evolution, wherein the catalyst is selected from cobalt oxide Co₃O₄), manganese oxide (Mn₃O₄ or MnO₂), cobalt-nickel oxide (CoNiO₂), lanthanum-calcium-cobalt oxide (LaₓCa₁₋ₓCoO₃), ruthenium oxide (RuO₂), iridium oxide (IrO₂), platinum (Pt), palladium (Pd), and mixtures thereof.

The composition of the cathode (gas diffusion electrode) in the secondary cell in accordance with the invention has various advantages which lead, among other things, to a high reversibility of the cell reactions. For one, the elementary Ag has a high catalytic activity in particular for the electrochemical oxygen reduction (ORR, oxygen reduction reaction), which proceeds at the cathode when discharging the cell. At the same time, the Ag ensures the conductivity of the cathode, such that an addition of carbon may be foregone. So that the electrochemical oxygen evolution (OER, oxygen evolution reaction) can also proceed effectively when charging the secondary cell, the mixture contains the further catalyst which is selected from the stated materials and in particular catalyzes the electrochemical oxygen evolution.

The cathode of the secondary cell in accordance with the invention thus not only has a high catalytic activity both for the oxygen evolution and the oxygen reduction, it is also corrosion-resistant and has a high stability due to its composition.

The silver and/or silver oxide contained in the cell (depending on the charge state of the cell) is not only important for the catalytic activity and the conductivity of the cathode, but also fulfills a further essential function in the secondary cell in accordance with the invention, in that it makes a contribution to the capacity of the cell in accordance with the principle of a silver oxide-zinc battery. Thus, as already mentioned at the outset, a hybrid system of a zinc-air battery and a silver oxide-zinc battery is present.

This hybrid system in accordance with the invention is particularly advantageous insofar as the electrochemical reactions involving silver and silver oxide have a lesser kinetic over-voltage than the reduction and evolution of oxygen, such that former reactions preferably proceed when charging and discharging the cell.

Thus when charging the secondary cell, first an oxidation of Ag to Ag₂O and then a further oxidation of the Ag₂O to AgO occurs according to the following reaction equations:

2Ag+2OH⁻→Ag₂O+H₂O+2e⁻ (1)

Ag₂O+2OH⁻→2AgO+H₂O+2e⁻ (2)

These reactions proceed very quickly due to the low over-voltage, and also because no gas diffusion processes are involved.

Thus when discharging the cell, first the reduction of the silver oxide occurs in the opposite direction of these reactions.

If the capacity of the system of silver/silver oxide is exhausted when charging or discharging the cell, or if when discharging the cell the discharge current exceeds a certain value, then a further, larger capacity of the secondary cell is provided through the evolution and reduction, respectively, of oxygen from the ambient air, according to the following reaction equation (for the charging process):

4OH⁻→O₂+2H₂O+4e⁻ (3)

At the anode, the reduction of zinc oxide (in the charging process) via the intermediate step of zinc hydroxide proceeds according to the following reaction equations:

ZnO+H₂O+2OH⁻→Zn(OH)₄²⁻ (4)

Zn(OH)₄²⁻+2e⁻→Zn+4OH⁻ (5)

This results in the following gross reaction for the first phase of the charging process (corresponding to a silver oxide-zinc battery):

2Ag+2Zn(OH)₂→2AgO+2Zn+2H₂O (6)

The gross reaction for the second phase of the charging process is (corresponding to a zinc-air battery):

2ZnO→2Zn+O₂ (7)

The use of a mixture of silver and a catalyst for the electrochemical oxygen evolution in a gas diffusion electrode is already known from the publication WO 2015/124713 A1, though not in connection with an anode containing zinc oxide, but rather in particular for a lithium-air battery. As opposed to the present invention, the silver serves in accordance with this prior art only as a conductive and catalytically active material, without an oxidation of the silver taking place there when charging the battery.

Of the catalysts stated above for the electrochemical oxygen evolution, Co₃O₄ is particularly preferable within the scope of the present invention. In an advantageous embodiment of the invention, the catalyst contains Co₃O₄ as the sole component.

The cathode favorably contains a proportion of 5 to 20% by weight of the catalyst, preferably of 10 to 15% by weight. With too small a proportion of the catalyst, the catalytic activity of the gas diffusion electrode is not high enough for the oxygen evolution. With too large a proportion of the catalyst, the proportion of silver sinks for far that the conductivity is no longer sufficient.

The cathode favorably further contains a binder which is selected from polytetrafluoroethylene (PTFE), polypropylene (PP), polyvinylidene fluoride (PVDF), and/or polyethylene (PE). Preferably PTFE is used as the binder. The binder is hydrophobic and ensures that the pores of the gas diffusion electrode are not completely flooded by the electrolyte, such that a three-phase boundary can form.

The cathode preferably contains 5 to 15% by weight of the binder, further preferably 8 to 12% by weight.

The proportion of silver/silver oxide in the cathode is preferably at least 65% by weight, further preferably at least 75% by weight.

The cathode of the secondary cell in accordance with the invention is favorably produced of silver particles, i.e. the system of silver/silver oxide is present after the production in the charged state of the cell. The cathode is preferably produced using silver particles with a particle diameter in the range of 5 to 30 μm, further preferably in the range of 10 to 20 μm.

The catalyst for the electrochemical oxygen evolution is likewise present in particle form in the production of the cathode. The cathode is preferably produced using particles of the catalyst, the particle diameter of which is smaller than 100 nm, preferably smaller than 50 nm.

The cathode preferably has a porosity in a range of 40% to 80%, further preferably in a range of 50% to 65%.

The cathode preferably contains no carbon. It is thus corrosion-resistant and retains its stability, even after a multitude of charge and discharge cycles.

The cathode and gas diffusion electrode, respectively, preferably has a thickness in a range of 350 to 700 μm, preferably in a range of 400 to 500 μm.

The cathode of the secondary cell in accordance with the invention may preferably be produced according to a method, as it is described in the publication WO 2015/124713 A1 stated above. Silver particles, particles of the catalyst and, as the case may be, binder particles are hereby mixed and compressed under high pressure. The mixture may then be heated to a temperature above the melting point of the binder in order to bond the particles to each other by superficially or completely melting the binder.

In the secondary cell in accordance with the invention, the entire amount of substance of silver in the cathode in the form of Ag, Ag⁺ and Ag³⁺ is less than the entire amount of substance of zinc in the anode in the form of Zn and Zn², wherein the ratio Ag/Zn is preferably in the range of 1:5 to 1:10. The amount of substance of zinc, which exceeds the amount of substance of silver, correlates with the amount of substance of oxygen that is evolved during a charge cycle and that is reduced during a discharge cycle, respectively.

In the secondary cell in accordance with the invention, the electrolyte is preferably an alkaline aqueous solution, in particular a potassium hydroxide solution (KOH). Due to the lower reactivity of zinc, in contrast to lithium-air batteries, no organic electrolyte must be used.

The present invention relates further to an accumulator which comprises one or a plurality of secondary cells in accordance with the invention. The individual cells are hereby connected in series. The accumulator preferably further comprises a housing in which the one or plurality of secondary cells are arranged, as well as an anode contact and a cathode contact which are connected to each other by way of a consumer when discharging and by way of a voltage source when charging.

Furthermore, the invention relates to a method for changing and a method for discharging the secondary cell in accordance with the invention or the accumulator in accordance with the invention.

In the charging method in accordance with the invention, in a first phase of the charging process, substantially only the oxidation of the present silver to silver oxide occurs in the cathode, and in a second phase additionally or exclusively the electrochemical evolution of oxygen.

In the discharging method in accordance with the invention, in a first phase of the discharging process, substantially only the reduction of the present silver oxide to silver occurs in the cathode, and in a second phase additionally or exclusively the electrochemical reduction of oxygen.

When discharging, a transition from the first phase into the second phase occurs preferably when no more silver oxide is present in the cathode or when the discharge current exceeds a certain value.

The secondary cell in accordance with the invention and the accumulator in accordance with the invention, respectively, may advantageously be used in various fields. Of particular interest here are mobile applications in which it is dependent on a high energy density, like for example electric vehicles, but also applications like hearing aids in which it dependent on a volume that is as small as possible. Possible stationary applications are, for example, accumulators for the storage of wind and solar energy, and generally for the smoothing of power peaks in power grids.

These and further advantages of the invention are explained in more detail using the following exemplary embodiments. In the drawings:

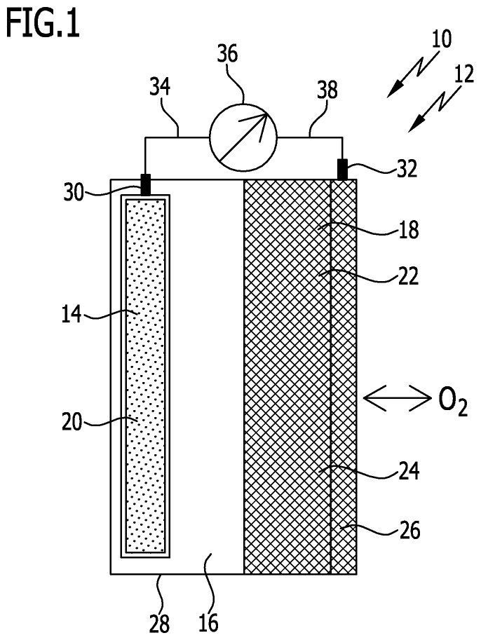

FIG. 1: shows a schematic depiction of a secondary cell in accordance with the invention; and

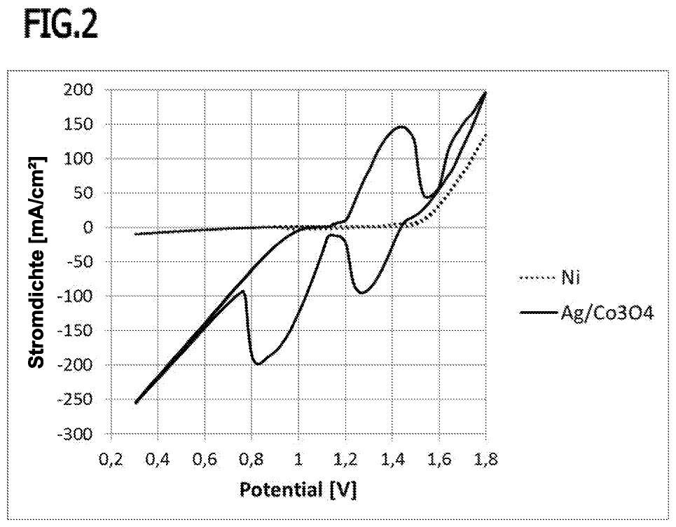

FIG. 2: shows cyclic voltammograms of a gas diffusion electrode with a mixture of Ag and Co₃O₄ and a pure nickel electrode.

Schematically depicted in FIG. 1 is the structure of a secondary cell in accordance with the present invention, referred to as a whole with the reference numeral 10. The secondary cell 10 is configured in the form of a hybrid system 12 of a zinc-air battery and a silver oxide-zinc battery. It comprises an anode 14 which is in contact with an electrolyte 16. Further, a cathode 18 of the secondary cell 10 is also in contact with the electrolyte 16.

The anode 14 contains zinc and/or zinc oxide 20, depending on the charge state of the secondary cell 10, wherein in the fully charged state only zinc and in the fully discharged state only zinc oxide is present.

The electrolyte 16 may in particular be an aqueous alkaline electrolyte. For example, a 7 molar KOH solution may be used.

The cathode 18 is configured as a gas diffusion electrode 22 with a porous structure in order to enable the electrochemical reactions involving oxygen (O₂) at a three-phase boundary of the solid/liquid/gas phases. The cathode 18 contains in accordance with the invention a mixture 24 of silver and/or silver oxide with a catalyst for the electrochemical oxygen evolution, like for example Co₃O₄. Optionally, the cathode 18 may be arranged on a cathode support 26, which allows the passage of oxygen. The support 26 may be configured, e.g., as metal foam, as metal mesh, or as expanded metal, in particular of stainless steel, nickel, or silver.

Optionally, the secondary cell 10 (or an accumulator comprising a plurality of secondary cells) may comprise a housing 28, out of which an anode contact 30 electrically conductively connected to the anode 14 protrudes. Analogously, a cathode contact 32 may be electrically conductively connected to the cathode 18, which contact projects out of the housing 28.

The anode contact 30 may be connected to a consumer 36 by way of a connecting line 34 and to the cathode contact 32 by way of a further connecting line 38 in order to bring about a current flow from the cathode 18 to the anode 14. Electrons hereby flow from the anode 14 to the cathode 18. The secondary cell 10 is hereby discharged. When charging the secondary cell 10, the current and the electrons flow in the respective other direction.

For producing a cathode 18 for a secondary cell 10 in accordance with the invention, in one embodiment, 70% by weight silver powder with a particle size of 10 to 30 μm, 20% by weight cobalt oxide powder with a particle size of under 50 nm and 10% by weight PTFE particles with a particle size of about 4 μm are mixed and preferably milled in a blade mill in order to obtain a homogeneous mixture. Strands form when mixing, which hold the mixture together, similarly to a spider web. A milling duration of the constituents is about 2 seconds.

After milling, the mixture 24 is filled into the flexible frame, covered with a stainless steel mesh, and compressed to a solid composite, preferably with a hydraulic press at a pressure of about 2.5 bar. The temperature when pressing is about 25° C. The mesh of stainless steel serves as a cathode support 26 on the one hand for improving the mechanical stability of the cathode 18 and as a current collector on the other hand.

Gas diffusion electrodes 22 are produced in the described manner as cathodes 18 for a secondary cell 10 with a thickness in the range of 450 μm.

For the electrochemical characterization of these gas diffusion electrodes, a cyclic voltammogram was measured, wherein a reversible hydrogen electrode (RHE) was used as a reference electrode and a platinum electrode and a counter electrode. A 7 molar KOH solution was used as an electrolyte and pure oxygen as a test gas.

Depicted in FIG. 2 is the cyclic voltammogram of the gas diffusion electrode with Ag/Co₃O₄ described above (continuous line), and for comparison the cyclic voltammogram of a pure nickel electrode measured under the same conditions (dotted line). The current density is plotted in mA/cm² against the potential voltage with respect to the RHE in V.

The progression in the lower part of the diagram for the discharging process of the Ag/Co₃O₄ electrode clearly shows a first peak at about 1.3 V for the reduction of AgO to Ag₂O and a second peak at about 0.8 V for the reduction of Ag₂O to Ag. Below this voltage, the reduction of oxygen occurs (ORR). Corresponding peaks are also visible in the upper part of the diagram for the charging process, at about 1.4 V for the oxidation of Ag to Ag₂O and at about 1.7 V for the oxidation of Ag₂O to AgO, wherein the latter is only weakly present. The evolution of oxygen (OER) occurs above this voltage.

### REFERENCE NUMERAL LIST

10 secondary cell
12 hybrid system
14 anode
16 electrolyte
18 cathode
20 zinc/zinc oxide
22 gas diffusion electrode
24 mixture of Ag/Ag₂O/AgO and catalyst
26 cathode support
28 housing
30 anode contact
32 cathode contact
34 connecting line
36 consumer
38 connecting line

1. A secondary cell in the form of a hybrid system of a zinc-air battery and a silver oxide-zinc battery, comprising an anode, a cathode, and an electrolyte, wherein:
the anode contains zinc (Zn) and/or zinc oxide (ZnO),
the cathode is configured as a gas diffusion electrode which contains a mixture of silver (Ag) and/or silver oxide (Ag₂O/AgO) with a catalyst for the electrochemical oxygen evolution,
the catalyst is selected from cobalt oxide (Co₃O₄), manganese oxides (Mn₃O₄ or MnO₂), cobalt-nickel oxide (CoNiO₂), lanthanum-calcium-cobalt oxide (LaₓCa₁₋ₓCoO₃), ruthenium oxide (RuO₂), iridium oxide (IrO₂), platinum (Pt), palladium (Pd), and mixtures thereof.

2. The secondary cell in accordance with claim 1, wherein the catalyst contains Co₃O₄, in particular as the sole component.

3. The secondary cell in accordance with claim 1, wherein the cathode contains a proportion of 5 to 20% by weight of the catalyst.

4. The secondary cell in accordance with claim 1, wherein the cathode further contains a binder which is selected from polytetrafluoroethylene (PTFE), polypropylene (PP), polyvinylidene fluoride (PVDF), and/or polyethylene (PE).

5. The secondary cell in accordance with claim 4, wherein the cathode contains 5 to 15% by weight of the binder.

6. The secondary cell in accordance with claim 1, wherein the cathode is produced using silver particles with a particle diameter in the range of 5 to 30 μm.

7. The secondary cell in accordance with claim 1, wherein the cathode is produced using particles of the catalyst, the particle diameter of which is smaller than 100 nm.

8. The secondary cell in accordance with claim 1, wherein the cathode has a porosity in a range of 40% to 80%.

9. The secondary cell in accordance with claim 1, wherein the cathode contains no carbon.

10. The secondary cell in accordance with claim 1, wherein the cathode has a thickness in a range of 350 to 700 μm.

11. The secondary cell in accordance with claim 1, wherein the entire amount of substance of silver in the cathode in the form of Ag, Ag⁺ and Ag³⁺ is less than the entire amount of substance of zinc in the anode in the form of Zn and Zn²⁺.

12. The secondary cell in accordance with claim 1, wherein the electrolyte is an alkaline aqueous solution.

13. An accumulator, comprising one or a plurality of secondary cells, wherein:
each of the one or a plurality of secondary cells being in the form of a hybrid system of a zinc-air battery and a silver oxide-zinc battery, comprising an anode, a cathode, and an electrolyte,
the anode contains zinc (Zn) and/or zinc oxide (ZnO),
the cathode is configured as a gas diffusion electrode which contains a mixture of silver (Ag) and/or silver oxide (Ag₂O/AgO) with a catalyst for the electrochemical oxygen evolution,
the catalyst is selected from cobalt oxide (Co₃O₄), manganese oxides (Mn₃O₄ or MnO₂), cobalt-nickel oxide (CoNiO₂), lanthanum-calcium-cobalt oxide (LaₓCa₁₋ₓCoO₃), ruthenium oxide (RuO₂), iridium oxide (IrO₂), platinum (Pt), palladium (Pd), and mixtures thereof.

14. A method for charging a secondary cell, the secondary cell being in the form of a hybrid system of a zinc-air battery and a silver oxide-zinc battery, comprising an anode, a cathode, and an electrolyte, wherein:
the anode contains zinc (Zn) and/or zinc oxide (ZnO),
the cathode is configured as a gas diffusion electrode which contains a mixture of silver (Ag) and/or silver oxide (Ag₂O/AgO) with a catalyst for the electrochemical oxygen evolution,
the catalyst is selected from cobalt oxide (Co₃O₄), manganese oxides (Mn₃O₄ or MnO₂), cobalt-nickel oxide (CoNiO₂), lanthanum-calcium-cobalt oxide (LaₓCa₁₋ₓCoO₃), ruthenium oxide (RuO₂), iridium oxide (IrO₂), platinum (Pt), palladium (Pd), and mixtures thereof,
wherein the method comprises in a first phase of the charging process, substantially only the oxidation of the present silver to silver oxide occurs in the cathode, and in a second phase additionally or exclusively the electrochemical evolution of oxygen.

15. A method for discharging a secondary cell, the secondary cell being in the form of a hybrid system of a zinc-air battery and a silver oxide-zinc battery, comprising an anode, a cathode, and an electrolyte, wherein:
the anode contains zinc (Zn) and/or zinc oxide (ZnO),
the cathode is configured as a gas diffusion electrode which contains a mixture of silver (Ag) and/or silver oxide (Ag₂O/AgO) with a catalyst for the electrochemical oxygen evolution,
the catalyst is selected from cobalt oxide (Co₃O₄), manganese oxides (Mn₃O₄ or MnO₂), cobalt-nickel oxide (CoNiO₂), lanthanum-calcium-cobalt oxide (LaₓCa₁₋ₓCoO₃), ruthenium oxide (RuO₂), iridium oxide (IrO₂), platinum (Pt), palladium (Pd), and mixtures thereof,
wherein the method comprises in a first phase of the discharging process, substantially only the reduction of the present silver oxide to silver occurs in the cathode, and in a second phase additionally or exclusively the electrochemical reduction of oxygen.

16. A method for charging an accumulator, the accumulator comprising one or a plurality of secondary cells, wherein:
each of the one or a plurality of secondary cells being in the form of a hybrid system of a zinc-air battery and a silver oxide-zinc battery, comprising an anode, a cathode, and an electrolyte,
the anode contains zinc (Zn) and/or zinc oxide (ZnO),
the cathode is configured as a gas diffusion electrode which contains a mixture of silver (Ag) and/or silver oxide (Ag₂O/AgO) with a catalyst for the electrochemical oxygen evolution,
the catalyst is selected from cobalt oxide (Co₃O₄), manganese oxides (Mn₃O₄ or MnO₂), cobalt-nickel oxide (CoNiO₂), lanthanum-calcium-cobalt oxide (LaₓCa₁₋ₓCoO₃), ruthenium oxide (RuO₂), iridium oxide (IrO₂), platinum (Pt), palladium (Pd), and mixtures thereof,
wherein the method comprises in a first phase of the charging process, substantially only the oxidation of the present silver to silver oxide occurs in the cathode, and in a second phase additionally or exclusively the electrochemical evolution of oxygen.

17. A method for discharging an accumulator, the accumulator comprising one or a plurality of secondary cells, wherein:
each of the one or a plurality of secondary cells being in the form of a hybrid system of a zinc-air battery and a silver oxide-zinc battery, comprising an anode, a cathode, and an electrolyte,
the anode contains zinc (Zn) and/or zinc oxide (ZnO),
the cathode is configured as a gas diffusion electrode which contains a mixture of silver (Ag) and/or silver oxide (Ag₂O/AgO) with a catalyst for the electrochemical oxygen evolution,
the catalyst is selected from cobalt oxide (Co₃O₄), manganese oxides (Mn₃O₄ or MnO₂), cobalt-nickel oxide (CoNiO₂), lanthanum-calcium-cobalt oxide (LaₓCa₁₋ₓCoO₃), ruthenium oxide (RuO₂), iridium oxide (IrO₂), platinum (Pt), palladium (Pd), and mixtures thereof,
wherein the method comprises in a first phase of the discharging process, substantially only the reduction of the present silver oxide to silver occurs in the cathode, and in a second phase additionally or exclusively the electrochemical reduction of oxygen.
